(19) United States
(12) Patent Application Publication
(10) Pub. No.: US 2012/0133121 A1
(43) Pub. Date: May 31, 2012

(54) TRANSFER FOIL COMPRISING OPTICALLY VARIABLE MAGNETIC PIGMENT, METHOD OF MAKING, USE OF TRANSFER FOIL, AND ARTICLE OR DOCUMENT COMPRISING SUCH

(75) Inventors: Anton Bleikolm, Ecublens (CH); Pierre Degott, Crissier (CH); Edgar Mueller, Fribourg (CH)

(73) Assignee: SICPA HOLDING SA, Prilly (CH)

(21) Appl. No.: 13/387,936

(22) PCT Filed: Jul. 21, 2010
(86) PCT No.: PCT/EP10/60577

§ 371 Date: Jan. 30, 2012

(30) Foreign Application Priority Data
Jul. 28, 2009 (IB) PCT/IB2009/006378

(51) Int. Cl. B32B 3/10; B05D 5/06; B42D 15/00; B32B 37/14; B32B 38/10; B05D 3/00; B32B 37/10

(52) U.S. Cl. 283/67; 427/598; 156/230; 283/85; 428/206

(57) ABSTRACT

The present invention concerns a transfer foil, comprising a release-coated carrier (1), and on said carrier a transfer coating layer (3) having the form of a design comprising oriented optically variable magnetic pigment (OVMP), the pigment orientation representing an image, indicia, or a pattern. Processes of making and using the foil, as well as documents carrying the foil are also disclosed.

### FIELD OF INVENTION

The present invention is in the field of transfer foil (decalcomania, decal, also called blocking foil) technology, as well as of its application for the protection of security documents and of generic items. More particularly, it concerns an optically variable decal or foil comprising magnetically orientated optically variable pigment particles in an ink or coating, as well as its production, use, and herewith protected articles.

### TECHNICAL BACKGROUND

### State of the Art

Optically variable transfer foil was introduced in 1989 by the Bank of Canada on their 20$ bill. This foil, based on a vapor-deposited multi-layer thin-film interference device, exhibited a gold-to-green color shift when changing from normal to grazing view. The transfer foil comprised a five-layer (ZrO₂/SiO₂/ZrO₂/SiO₂/ZrO₂) all-dielectric interference film, which was applied over a dark background (J. Rolfe, Optically Variable Devices for Use on Bank Notes, Proc. SPIE, Vol. 1210, 1990, pp 14-19; U.S. Pat. No. 3,858,977; U.S. Pat. No. 4,626,445).

Bank of Canada later replaced the five-layer all-dielectric interference film by a three-layer metal-dielectric-metal Fabry-Perot interference film, which was easier to produce, whilst having about the same color shift, but a higher luminous reflectance, and no need to be applied over a dark background (U.S. Pat. No. 4,705,300; U.S. Pat. No. 4,779,898; U.S. Pat. No. 5,648,165).

The said multi-layer thin-film interference film is produced on a release-coated carrier, which may be a PET foil, in a roll-to-roll vacuum coating machine. Prior to the application to an item, i.e. an article or document, an adhesive layer is applied to the interference film and/or printed onto the article or document at the locations whereupon the interference film is to be transferred. The interference film is then applied to the article or document by a transfer method such as hot- or cold-stamping, and the release-coated carrier is removed.

An important shortcoming of the said optically variable transfer foil is its mechanical fragility. In fact, the applied interference film, unless particularly protected, can be easily broken and removed from the document, e.g. with the help of a pencil rubber. For this reason, the optically variable interference film transfer foil has eventually been replaced by optically variable ink in currency applications.

Further to the shortcoming of mechanical fragility, the said optically variable interference film transfer foils suffer from a lack of artistic design flexibility. It is noteworthy only possible in this way to transfer a single type of interference device, showing determined “color” and “color-shifting” properties, to the article or document. The artistic freedom of the designer remains in consequence limited to the choice of the color and the color-shifting properties, as well as the form of the transferred pattern. Attempts have been made to improve the limited design capability of the optically variable thin-film transfer foil through an additional embossing of the applied thin-film device (Securigrafix™ device of Security Foiling, UK), but the achievable artistic effects remained poor.

The mechanical fragility, as well as the intrinsic artistic design limitations of the optically variable transfer foil are overcome through the use of optically variable inks (OVI), in conjunction with appropriate printing techniques (U.S. Pat. No. 4,434,010; U.S. Pat. No. 5,059,245; U.S. Pat. No. 5,084,351; U.S. Pat. No. 5,171,363; U.S. Pat. No. 5,653,792 and EP 0 227 423 (Phillips et al.)). Optically variable inks comprise flake-shaped optically variable pigment (OVP), obtained through comminution of a vacuum-deposited 5-layer Fabry-Perot interference film having a symmetric (metal/dielectric/metal/dielectric/metal) type, e.g. a Cr (3.5 nm)/MgF₂ (200 nm)/Al (60 nm)/MgF₂ (200 nm)/Cr (3.5 nm) layer sequence. The flake-shaped particles have a diameter of typically between 10 to 50 μm and a thickness of typically between 0.5 and 5 μm.

The two outmost metal layers of the interference film are embodied as semi-transparent/semi-reflecting layers, and the central metal layer is embodied as a totally reflecting, opaque layer. The color and the color variation with viewing or incidence angle of the interference film are determined by the thickness and the refractive index of the dielectric layers, as well as by the optical properties of the materials used to make the interference film. In the art, the term “absorber layer” is also used to designate such a semi-transparent/semi-reflecting layer.

To make an optically variable ink (OVI), at least one type of optically variable pigment (OVP) is mixed, if required together with other pigments and/or dyes and/or printing additives, into an appropriate ink binder comprising at least one resin. The so obtained optically variable ink can be printed, if required in combination with other inks, in the form of an image, indicia, or a pattern on a substrate, which may be a security document or a generic article.

Appealing artistic designs can therewith be realized, using standard printing techniques and existing printing equipment, through appropriately combining different inks to form a printed image. Optically variable ink (OVI) has been printed on currency for the first time in Thailand (1987, 60 Baht commemorative issue), and later in Germany and in France (1000 DEM: 27.10.1992; 50 FRF: 20.10.1993); at present it has been adopted as a standard on most currencies of the world.

A further development in the field of the optically variable security features is the use of optically variable magnetic ink (OVMI), comprising optically variable magnetic pigment (OVMP). Such pigment has been disclosed in e.g. U.S. Pat. No. 4,838,648; WO 02/073250; EP 686 675; WO 03/00801; U.S. Pat. No. 6,838,166; WO 2007/131833. The optically variable pigment particles in an optically variable magnetic ink can be oriented after printing, through the application of an appropriate unstructured (i.e. homogeneous) or structured (i.e. varying in space) magnetic field, and then fixed in their respective positions and orientations by hardening the printed ink composition on the substrate. “Oriented” optically variable magnetic ink has recently been used on banknotes (Olympic Games 2008 commemorative notes of China (10 RMB) and of Macao (20 Pataca); Kazakh commemorative note (5000 Tenge)).

Materials and technology for the orientation of magnetic particles in a coating composition, and corresponding combined printing/magnetic orienting processes have been disclosed in U.S. Pat. No. 2,418,479; U.S. Pat. No. 2,570,856; U.S. Pat. No. 3,791,864; DE 2006848-A; U.S. Pat. No. 3,676,273; U.S. Pat. No. 5,364,689; U.S. Pat. No. 6,103,361; US 2004/0051297; US 2004/0009309; EP-A-710508, WO 02/090002; WO 03/000801; WO 2005/002866, and US 2002/0160194, as well as in the co-pending application PCT/IB2008/003406 of the same applicant.

Inks can furthermore be used as appropriate vectors for the incorporation of additional, specifically designed overt (i.e. visible to the human eye) and/or covert (i.e. invisible to the human eye) security elements (markers), such as luminescent materials, or of forensic taggants, which all allow for the genuineness determination (authentication) of the herewith marked document.

An important issue in the security document printing industry is the providing of a secure supply chain, in order to prevent counterfeiting and diversion of the produced security documents, as well as of key materials used to produce them.

Optically variable ink (OVI) and optically variable magnetic ink (OVMI) used for the printing of banknotes and similar security documents are, for these reasons, exclusively supplied to a restricted, accredited printer community, chosen among the world's established high-security banknote printing works.

On the other hand, there is considerable market potential for optically variable security elements on a large number of documents other than banknotes, such as transportation tickets, event tickets, tax excise stamps, credit cards, access cards, certificates, tax labels, and others of the kind, which are not normally printed by an accredited banknote printer, but by one of the numerous other security printing works who are not necessarily equipped for the printing of optically variable ink (OVI) or optically variable magnetic ink (OVMI). There is thus a long-felt need to serve this market, and the present invention is aimed at addressing this need.

### SUMMARY OF THE INVENTION

The present invention provides, as hereafter disclosed and defined by description, figures and claims, a transfer foil (decalcomania, decal, also called blocking foil) comprising oriented optically variable magnetic pigment particles in a binder resin, preferably in the form of an optically variable magnetic ink or coating (OVMI). The transfer foil is semi-finished product, which can be produced in a dedicated security printing environment, equipped for the printing and orienting of optically variable magnetic ink, and which can be applied to a security document or to a generic item in a different environment, equipped for the application of transfer foils.

The transfer foil of the present invention provides a large freedom for customization, in that it can be uniquely specified and designed for every given application. It also cuts short to misuses (diversion) of optically variable magnetic ink, which might occur outside the dedicated security printing environment, whilst preserving the application potential of optically variable magnetic features on documents or articles which are not normally produced in a dedicated security printing environment.

The transfer foil of the present invention further provides a highly secure optically variable element, which is easily authenticate-able by the unaided eye, and which cannot be easily counterfeit with commonly accessible means.

According to the present invention, the transfer foil (decalcomania, decal, also called blocking foil) comprises a release-coated carrier (1), and, disposed on said carrier, a transfer coating layer (transferable part) (3) in the form of a design, and is characterized in that said transfer coating layer (3) comprises oriented optically variable magnetic pigment (OVMP) particles. An adhesive layer (4), as known in the art, may additionally be disposed on said transfer coating layer (3).

The transfer coating layer (3) comprising oriented optically variable magnetic pigment particles in a binder resin may further be a composite layer, comprising layers or parts of layers not made with optically variable magnetic ink, but being an integral part of the said design, i.e. of the transferable part of the transfer foil.

Said transfer coating layer carrying said design, which may be an image, indicia, or a pattern, can subsequently be transferred, in a hot-stamping or cold-stamping process as known in the art, to a substrate, such as a security document (e.g. a banknote, a passport, an identity card, an access card, a driving license, a credit card, a voucher, a transportation ticket, an event ticket, a tax label), or a generic article or document (e.g. a brand label or a commercial good). After the transfer of the transferable part of the transfer foil to the document or article, the carrier is removed from the applied transfer coating layer.

### DETAILED DESCRIPTION

The transfer foil of the present invention comprises oriented optically variable magnetic pigment (OVMP) particles, preferably comprised in a solidified optivariable magnetic ink or coating (OVMI) layer.

Transfer foils and decals are well known to the skilled in the graphic and decorative arts, and used for transferring prefabricated indicia, images or patterns onto products such as textiles, documents, or generic items (U.S. Pat. No. 5,393,590; U.S. Pat. No. 5,681,644; U.S. Pat. No. 5,925,593, U.S. Pat. No. 6,808,792, EP 0 538 358; EP 0 538 376). The indicia, images or patterns are hereby pre-formed as a mirror-image by printing and/or other application techniques, on a release-coated intermediate carrier, such as a plastic foil or a transfer paper, and transferred in a second step to the destination item by an appropriate transfer technique, such as hot- or cold-stamping. The intermediate carrier is eventually removed, leaving the neat transferable layer, carrying the indicia, images or patterns, on the destination item.

A design, in the context of the present disclosure, shall mean everything which can be produced by a printing or coating process, including vacuum-coating, pre- and post-treatments, as well as magnetic pigment orientation.

Oriented optically variable magnetic pigment (OVMP) particles, in the context of the present description, means pigment particles which are present in the coating in an orientation different from the one they would adopt as the result of a simple printing process. In the context of the present invention, oriented pigment particles are obtained through the application of a homogeneous or appropriately structured external magnetic field to the freshly applied coating layer, followed by fixing the pigment particles in their adopted respective positions and orientations through a hardening (solidifying, drying, curing) process, as disclosed in EP 1 641 624 B1 and WO 2008/046702 A1.

Preferably, the pigment particle orientation represents an image, indicia, or a pattern.

Preferably the optically variable magnetic pigment (OVMP) is a magnetic thin-film interference pigment chosen from the group consisting of the Fabry-Pérot type interference pigments and the all-dielectric, refractive-index-modulated type interference pigments. The magnetic properties are conferred to the pigment particle by its comprising of at least one magnetic or magnetizable material in at least one of its constituting layers.

Most preferably, the optically variable magnetic pigment (OVMP) is chosen from the group consisting of the pigments comprising a 5-layer sequence of absorber layer, dielectric layer, reflector layer, dielectric layer, absorber layer, wherein the reflector layer and/or the absorber layer is a magnetic layer, and the pigments comprising a 7-layer sequence of absorber layer, dielectric layer, reflector layer, magnetic layer, reflector layer, dielectric layer, absorber layer.

The binder resin of the said transfer coating layer (3) is advantageously chosen from the group consisting of the thermoplastic resins, the photo-curable resins, the electron-beam-curable resins and the heat-curable resins.

Preferably, the transfer foil additionally comprises, at least on part of the extension of said transfer coating layer, a layer of heat or radiation activateable adhesive (4). Most preferred is a layer of heat activate-able adhesive, chosen from the group consisting of the naturally occurring and the synthetic thermoplastic resins. Examples of thermoplastic resins are shellac, phenol-formaldehyde resins, vinyl-acetate resins, ethylene-vinyl-acetate resins, polyamides, poly-vinylchlorides, acrylic resins, poly-urethane-acrylates, poly-esteracrylates, poly-siloxane-acrylates, etc.

The thermoplastic resin should become tacky in a temperature range which is useful for hot-stamping applications, i.e. 65° C. to 180° C., most preferred 80° C. to 120° C. Preferred are further those thermoplastic resins which irreversibly cross-link in the fused state, providing for a durable fixation of the transferred coating on the final substrate.

The chemical nature of the adhesive must be adapted, as known to the skilled person, to the chemical nature of the substrate onto which the transfer foil is to be applied. Although the choice of appropriate glues is outside the scope of the present invention, it is known to the skilled in the art that, for application onto paper substrates, the adhesive must have hydrogen-bonding capability, i.e. comprise hydrogen-bonding functional groups such as phenols, carboxylates, amides, urethanes, or the like.

In certain cases, a mediator layer may be required between the transfer coating layer (3) and the adhesive layer (4), in order to provide for sufficient adhesion at this interface; alternatively the chemistry of the transfer coating layer (3) may also be modified such as to firmly adhere to the chosen adhesive layer (4).

Alternatively, the transfer coating layer (3) could be itself embodied as a thermoplastic layer, and directly transferred to a substrate by hot-stamping. However, this combination is not preferred, given the fact that the magnetic orientation of the pigment particles in the transfer coating layer (3) would be more or less lost under the influence of heat.

In another considered embodiment, the transfer foil additionally comprises, at least on part of its extension, a top coating layer (6), disposed between the release-coated carrier (1) and the transfer coating layer (3).

In a further considered embodiment, the transfer foil additionally comprises, at least on part of its extension, a bottom coating layer (6′), disposed on the transfer coating layer (3) or between the transfer coating layer (3) and the adhesive layer (4).

The transfer coating layer (3) of the transfer foil according to the present invention, in the form of a design, is preferably a composite layer, which comprises layers or parts of layers not made with optically variable magnetic ink. The composite layer has thus at least one zone printed with a first ink comprising oriented optically variable magnetic pigment, and at least one further zone printed with a second ink comprising other types of pigments and/or dyes.

Said other types of pigments and/or dyes may noteworthy comprise non-magnetic optically variable pigments, transparent optically variable pigments, additive-color-mixing pigments, iridescent pigments, liquid crystal polymer pigments, metallic pigments, magnetic pigments, UV-, visible- or IR-absorbing pigments, UV-, visible- or IR-luminescent pigments, UV-, visible- or IR-absorbing or luminescent dyes, as well as mixtures thereof.

Additive-color-mixing pigments are optically opaque reflecting pigments, which selectively reflect determined parts of the visible spectrum whilst screening all reflection from the background. Such pigments can be embodied by colored metallic pigments or by opaque interference pigments. Colored metallic pigments are not optically variable. Interference pigments relying on high-refractive-index dielectric materials (n larger 2) generally show only a small, negligible color-shift with viewing angle, and therefore do not appear as optically variable. Interference pigments relying on low-refractive-index dielectric materials (n smaller 1.65) generally show appreciable color-shift with viewing angle, and therefore appear as optically variable. The optical variability of the borderline cases between these refractive index limits must be individually judged at the sensitivity of the specific color of the pigment to the viewing angle; yellow being more sensitive than e.g. blue or red.

In the transfer foil according to the present invention, a top coating layer (6) or a bottom coating layer (6′) can further be a metallic layer; and said metallic layer may additionally represent or carry indicia.

Finally, the ink layer (3) comprising optically variable magnetic pigment may further comprise other types of pigments and/or dyes, such as a second type of optically variable magnetic pigment, a non-magnetic optically variable pigment, a transparent optically variable pigment, an iridescent pigment, a liquid crystal polymer pigment, a magnetic pigment, a metallic pigment, further a luminescent pigment or dye, an absorbing pigment or dye, both in the visible and/or IR spectral domain, as well as mixtures thereof. It may furthermore carry specifically designed overt (i.e. visible to the human eye) and/or covert (i.e. invisible to the human eye) security elements (markers), such as luminescent materials, or of forensic taggants, which all allow for the genuineness determination (authentication) of the herewith marked document.

Further disclosed is a process for making an optically variable transfer foil, the process comprising the steps of
a) providing a release-coated carrier (1);
b) optionally coating said carrier (1) with a top coating layer (6);
c) applying onto said release-coated carrier (1) or on said top coating layer (6) a transfer coating layer (3) comprising magnetic or magnetizable optically variable pigment particles (5);
d) magnetically orienting said magnetic or magnetizable optically variable pigment particles (5) in said applied transfer coating layer (3) through the application of an unstructured or an appropriately structured magnetic field;
e) hardening said transfer coating layer (3) comprising the oriented optically variable pigment particles, so as to fix them in their respective positions and orientations;
f) optionally coating said transfer coating layer (3) with a bottom coating layer (6′).

In a particularly preferred embodiment, the process comprises the additional step of
g) applying a layer of adhesive onto the transfer coating layer (3) or the bottom coating layer (6′).

Also disclosed is a process for protecting a document or an article, using a transfer foil according to the present invention, the process comprising the steps of
a) applying onto the document or article a transfer coating layer (3) from a transfer foil according to the present invention, using an application method chosen from hot-stamping and cold-stamping;
b) removing the carrier (1) from the applied transfer coating layer (3).

The optically variable transfer foil according to the present invention can be used for the protection of documents, such as banknotes (currency), passports, identity or access cards, driving licenses, credit cards, vouchers, transportation tickets, event tickets, tax labels, further for the protection of items such as articles or commercial goods, etc. by the application of the transfer coating layer (3) from the transfer foil onto the document, good or article.

Disclosed is also a document, such as a banknote, a passport, an identity or access card, a driving license, a credit card, a voucher, a transportation ticket, an event ticket, a tax label, or an item, such as an article or a commercial good, carrying a transfer coating layer (3) according to the present invention.

The transfer foil according to the present invention, its production, and its use are now further explained with reference to the drawings and to exemplary embodiments.

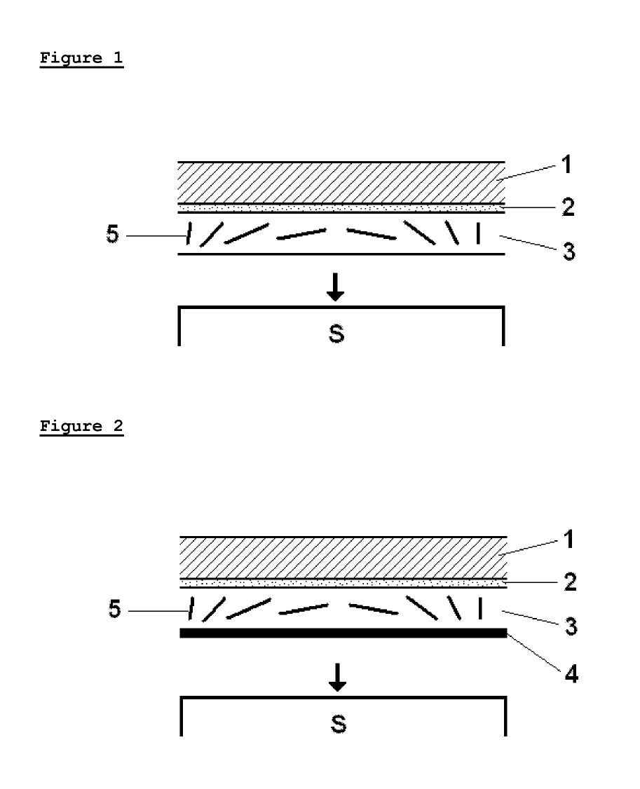

FIG. 1 illustrates a first embodiment of the transfer foil of the present invention, comprising a release-coated (2) carrier (1) and a transfer coating layer (3) comprising oriented optically variable magnetic pigment (5).

FIG. 2 illustrates a second embodiment of the transfer foil of the present invention, additionally comprising an adhesive layer (4).

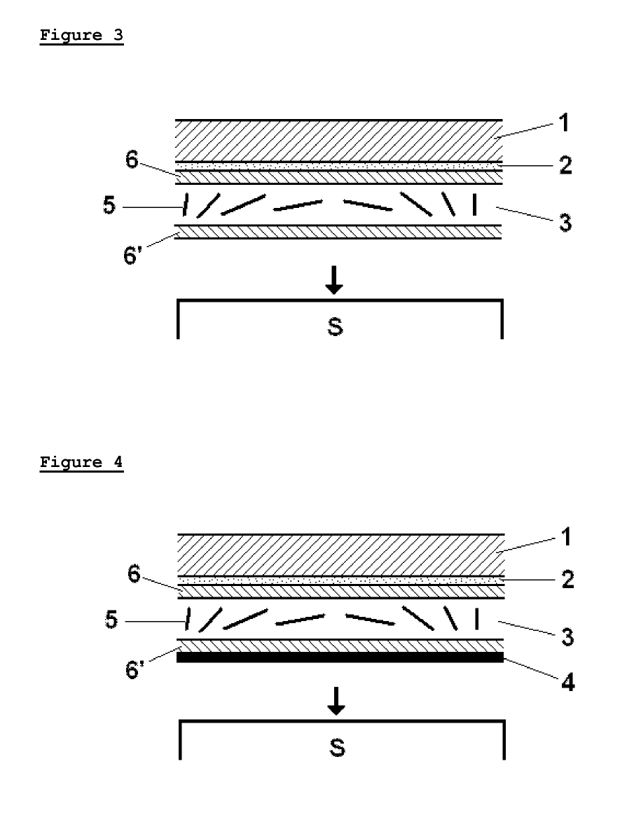

FIG. 3 illustrates a third embodiment of the transfer foil of the present invention, additionally comprising top- and/or bottom-coating layers (6, 6′).

FIG. 4 illustrates a fourth embodiment of the transfer foil of the present invention, additionally comprising top- and/or bottom-coating layers (6, 6′) and an adhesive layer (4).

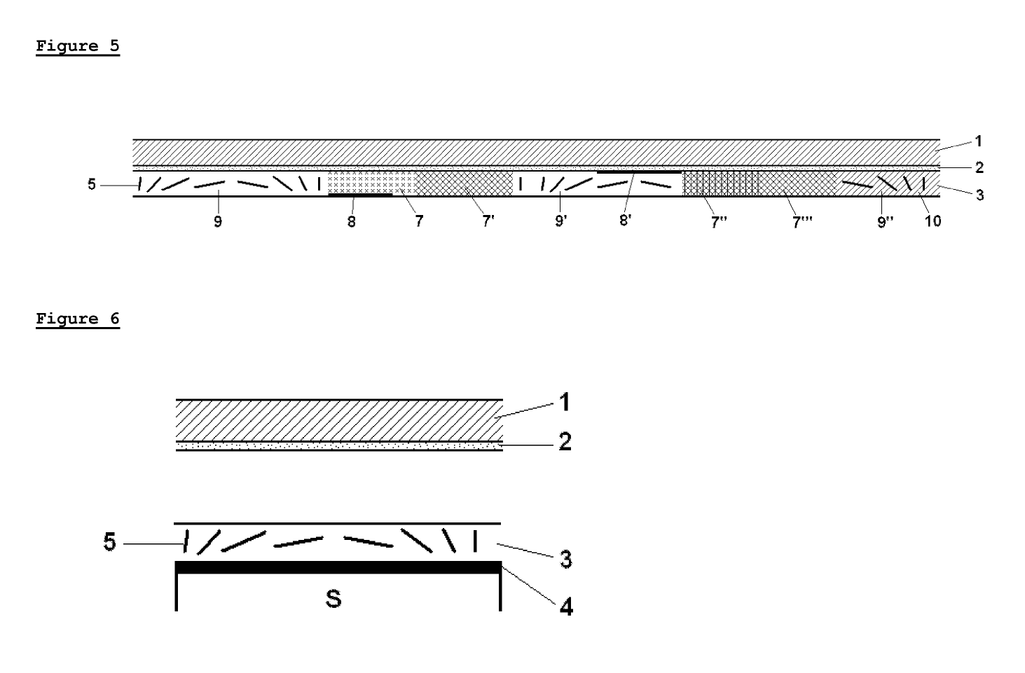

FIG. 5 illustrates a further embodiment of the transfer foil of the present invention, having a composite transfer coating layer (3), having zones printed with a first ink comprising oriented optically variable magnetic pigment, and zones printed with second inks comprising other types of pigments and/or dyes.

FIG. 6 illustrates the transfer foil of FIG. 2, applied to a substrate (S), with the carrier (1) removed.

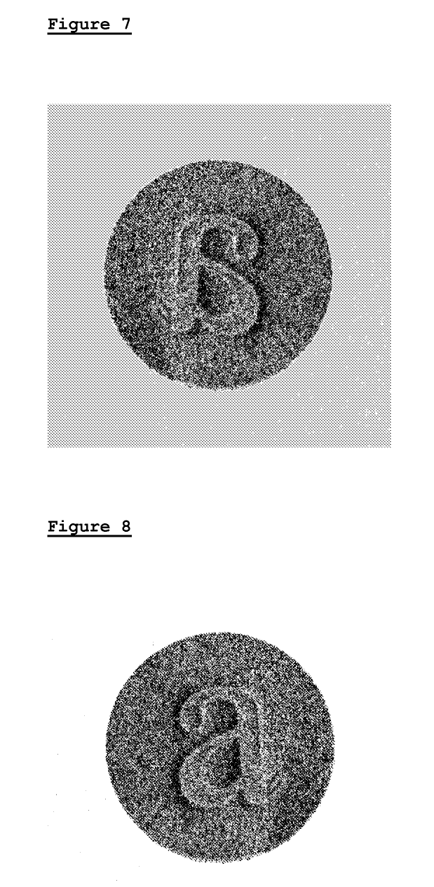

FIG. 7 shows a photograph of a transfer foil produced according to the example given below, as seen from the printed side of the carrier. The cured ink patch on the release-coated substrate displays the image of the reversed letter “a”.

FIG. 8 shows a photograph of a transfer foil according to the example given below, after application to a substrate.

The optically variable transfer foil according to the present invention comprises, with reference to FIGS. 1 to 4, a carrier (1) having a release-coating (2) applied on its surface, and on said release coating (2) a transfer coating layer (3) comprising oriented optically variable magnetic pigment (OVMP) (5). A layer of thermally or otherwise activate-able adhesive (4) may be provided on the transfer coating layer (3). One or more additional top coating layers (6) may be provided between the release coating (2) and the transfer coating layer (3), i.e. on the top of the transfer foil. Further additional bottom coating layers (6′) may be provided over the transfer coating layer (3), or between the transfer coating layer (3) and the adhesive layer (4), respectively.

The foil is preferably applied onto a substrate (S) by a transfer method chosen from hot-stamping and cold-stamping, optionally combined with a curing step. After the application of the foil, the carrier (1) having a release-coating (2) is removed, leaving the transfer coating layer (3) or, in case, a top coating layer (6) exposed at the surface of said substrate (S).

The optically variable transfer foil according to the present invention can thus be a hot-stamping foil, in which case either the transfer coating layer (3), or the adhesive layer (4) must be either a thermoplastic layer or a heat-activate-able adhesive layer. The transfer coating layer (3) and/or the adhesive layer (4) may also comprise radiation-curable functionality, enabling its final hardening (curing) by UV or electron beam radiation concomitant with or after the application of the transfer coating layer to a document or article.

The carrier (1) may be chosen of paper or of plastic (e.g. PET), as known to the skilled in the art. The release coating (2) may be a siliconized coating, such as known in the art. Siliconized surfaces are known to detach-ably adhere to coatings of all kind applied onto them. Siliconized paper and wax paper are known to the skilled person as suitable substrates for making transfer foils.

With reference to FIG. 5, and in a particularly preferred embodiment, the transfer coating layer (3) is a composite layer, comprising zones printed with “oriented” optically variable magnetic inks (9, 9′, 9″), and zones printed with inks (7, 7′, 7″, 7′″) comprising other types of pigments and/or dyes, according to the design of the transfer foil. Metallized surfaces (8, 8′) may further be provided on or in the transfer coating layer (3), which may further carry or represent indicia. The optically variable magnetic inks (9″) may further contain other types of pigments and/or dyes (10).

These other types of pigments and/or dyes (10), as well as the other types of pigments and/or dyes in the inks (7, 7′, 7″, 7′″) may be chosen from the spectrally selective absorbing pigments, the spectrally selective reflecting pigments, the spectrally selective emitting (luminescent) pigments in the UV (300-400 nm), visible (400-700 nm), and IR (700-2500 nm) range, and the light polarizing pigments based on crosslinked nematic or cholesteric molecular textures. The pigments may further be chosen from the magnetic pigments, as well as from the forensic marking pigments. For useful pigments and dyes, the skilled man may also refer to O. Lückert, Pigment+Füllstoff Tabellen, 5. Ed., Laatzen, 1994, which is incorporated herein by reference.

The optically variable magnetic ink (9, 9′, 9″) preferably comprises optically variable magnetic or magnetizable pigment particles of the kind disclosed in e.g. U.S. Pat. No. 4,838,648; WO 02/073250; EP 686 675; WO 03/00801; U.S. Pat. No. 6,875,522; U.S. Pat. No. 6,838,166; and WO 2007/131833.

The most preferred pigment to be used in the present invention is either a flake-shaped 5-layer Fabry-Perot interference film pigment according to U.S. Pat. No. 4,838,648, of the symmetric (absorber/dielectric/magnetic/di-electric/absorber) type, having e.g. a Cr (3.5 nm)/MgF₂ (200 nm)/Ni (100 nm)/MgF₂ (200 nm)/Cr (3.5 nm) layer sequence, or a flake-shaped 5-layer Fabry-Perot interference film pigment of the symmetric (magnetic absorber/dielectric/reflector/dielectric/magnetic absorber) type, having e.g. a Ni (5 nm)/MgF₂ (250 nm)/Al (40 nm)/MgF₂ (250 nm)/Ni (5 nm) layer sequence, or a flake-shaped 7-layer Fabry-Perot interference film pigment according to U.S. Pat. No. 6,875,522, of the symmetric (absorber/dielectric/reflector/magnetic/reflector/dielectric/absorber) type, having e.g. a Cr (3.5 nm)/MgF₂ (200 nm)/Al (40 nm)/Ni (100 nm)/Al (40 nm)/MgF₂ (200 nm)/Cr (3.5 nm) layer sequence.

In the 5-layer structure, the central magnetic layer must also have appreciable light-reflecting properties, in order to provide for a bright interference color of the pigment. Alternatively, the thin external absorber layers could provide magnetic properties to the 5-layers pigment. This restricts the number of useful materials for making the magnetic layer(s). In the 7-layer structure, the magnetic material can be chosen independently of its light-reflecting properties, which provides a large freedom for the selection of materials with appropriate magnetic properties. Of course, the pigment structure can comprise additional layers, providing the pigment with supplementary or enhanced functionality.

In a most preferred embodiment, the color-generating, optically variable structure of the pigment is of the reflector/dielectric/reflector Fabry-Pérot type, wherein at least one of the reflector layers, which can be metal layers, is partially light-transmitting, in order to allow light from the exterior to enter the Fabry-Pérot structure and to produce interference. In an alternative embodiment, the color-generating, optically variable structure of the pigment is of the all-dielectric refractive index modulated type, comprising alternate layers of materials with different refractive indices. An example of such a structure, showing a gold-to-green shift with viewing angle, comprises the layer sequence ZrO₂ (75 nm)/SiO₂ (302 nm)/ZrO₂ (75 nm) SiO₂ (302 nm)/ZrO₂ (75 nm). ZrO₂ and SiO₂ have refractive indices of 2.2 and 1.54, respectively. The skilled person is referred to J. A. Dobrowolski, “Optical Thin-Film Security Devices”, in “Optical Document Security”, R. L. van Renesse, 2^{nd} edition, Artech House, London, 1998, ch. 13, pp. 289-328, which is incorporated herein by reference, as well as to the therein cited documents. In all cases there must be appropriate provision for conferring the pigment particles the required magnetic properties. Such can be achieved if they comprise at least one magnetic or magnetizable material in at least one of their constituting layers.

A particular case of a stable, refractive index modulated, all-dielectric color-generating structure are the cholesteric liquid crystal polymers (CLCP), known e.g. from U.S. Pat. No. 5,798,147, U.S. Pat. No. 6,899,824, WO 2008/000755 A1, EP 1 213 338 B1; EP 0 685 749 B1; DE 199 22 158 A1; EP 0 601 483 A1; DE 44 18 490 A1; EP 0 887 398 B1, WO2006/063926, U.S. Pat. No. 5,211,877, U.S. Pat. No. 5,362,315, and U.S. Pat. No. 6,423,246. CLCP pigments comprising magnetic material and CLCP-coated magnetic core particles can also be used as the optically variable magnetic pigment in the present invention.

The optically variable magnetic ink (OVMI) is most preferably applied using the screen-printing process. Screen-printing allows noteworthy to apply the required coating thickness, which is of the order of 10 μm to 50 μm, in a simple and rapid way. However, other printing processes can, with the required skill, also be used for the same purpose, noteworthy the intaglio printing, the flexographic printing and the gravure printing processes.

Concomitant or subsequent to the application or printing of the OVMI, the magnetic or magnetizable pigment particles in the ink are oriented through the application of an unstructured or appropriately structured magnetic field, as known in the art.

The ink comprising the oriented magnetic or magnetizable particles is then hardened so as to fix the particles in their respective orientations and positions. Appropriate hardening, drying or curing mechanisms are known to the skilled person, and the ink can be formulated in correspondence with the available drying/hardening equipment. A preferred hardening process in the context of the present invention is through radiation curing (i.e. photo-curing or electron-beam-curing), most preferably through UV-curing. UV-curing has the advantage of causing instant-hardening, allowing for highest production speeds at moderate equipment cost.

The additional coating layers (6, 6′) between the release coating (2) and the transfer coating layer (3), or between the transfer coating layer (3) and the substrate (S), or the adhesive layer (4), respectively, may be of any type known and used by the skilled in the art. In particular, a coating layer (6, 6′) may be chosen as a metal layer, which may additionally represent or carry indicia. Such indicia may, e.g. be embodied in the metal layer through selective etching, embossing or printing.

Depending on the application process, the transferred prefabricated transfer coating layer (3) may be subject, on the document or article, to post-treatments, such as additional curing through treatment with chemicals and/or radiation (UV, e-beam), or varnishing with an appropriate protecting varnish.

### EXEMPLARY EMBODIMENT OF THE INVENTION

### Transfer Foil Comprising Oriented Optically Variable Magnetic Pigment of the Comminuted Thin Film Fabry-Perot Type

A UV-curing silkscreen ink comprising optically variable magnetic pigment was formulated as follows (by weight):

| | |
|---|---|
| Epoxyacrylate oligomer (i.e Sartomer CN120A75) | 40% |
| Trimethylolpropane triacrylate (TMPTA) monomer (1) | 10% |
| Tripropyleneglycol diacrylate (TPGDA) monomer (2) | 10% |
| Genorad 16 (Rahn) | 1% |
| Aerosil 200 (Degussa-Huels) | 1% |
| Irgacure 500 (CIBA) | 6% |
| Genocure EPD (Rahn) | 2% |
| Pigment (#) | 20% |
| Dowanol PMA | 10% |

(1) Industrial commodity (e.g. Sartomer SR351)
(2) Industrial commodity (e.g. Sartomer SR306)
(#) Pigment: magenta-to-green 5 layer optically variable magnetic pigment, supplied by FLEX Products Inc., JDS Uniphase, Santa Rosa, CA, USA.
(#) For making other inks, the pigment is replaced by the same weight amount of other pigment(s).

The pigment was stirred into the homogeneous mixture of resins and additives. The viscosity was adjusted with Dowanol PMA/fumed silica to a target viscosity comprised between 500 to 800 mPa·s (Brookfield).

The magenta-to-green optically variable magnetic ink was screen-printed in the form of a circular patch on a silicone-release-coated paper carrier using a mesh size of 70 threads/cm (opening of the screen cells about 80 microns). Subsequent to printing, the wet printed ink patch on the carrier was exposed to the magnetic field of an engraved permanent magnetic plate according to EP 1 641 642 B1, which was, to this aim, temporarily disposed under the imprinted carrier. The permanent magnetic plate was a “Plastoferrite” plate, magnetized in perpendicular direction to its engraved surface, and engraved to a depth of 0.3 mm in the form of a reversed letter “a”. After exposure to the magnetic field of the engraved permanent magnetic plate, the ink patch was hardened (cured) under UV light (2 lamps of 200 W/cm), hereby fixing the positions and orientations of the optically variable magnetic pigment particles irreversibly in the ink matrix.

Please note that all printing and magnetic orienting must be done in mirror-reversed orientation, in order to allow the design to display right after application of the transferable part of the foil to a substrate.

A thermoplastic adhesive coating (commercial 1:5 shellac in ethanol, viscosity-adjusted to 800 mPa·s with ethanol/fumed silica) was applied in a further step on top of the UV cured ink patch by screen printing. After drying, the printed patch had the aspect shown in FIG. 7.

The printed patch was transferred to a white, untreated paper under laboratory conditions (using a hot iron at 120° C.), and the release-coated paper carrier was removed. The transferred patch had the aspect shown in FIG. 8.

In a similar way, composite transfer coating layers, having zones printed with “oriented” optically variable magnetic ink, and zones printed with second inks comprising other types of pigments and/or dyes, were made.

A particular example comprised a circular patch of “magenta-to-green” optically variable magnetic ink, oriented to display the letter “a” as in the example above, but surrounded by an annular zone of magenta ink, color-matched such as to display the same color as the optically variable ink at orthogonal incidence. The two inks were printed in two subsequent screen printing passes followed by UV-curing each time.

In a variant of this example, the surrounding annular zone was printed with a second optically variable ink having a lower color shift in function of the viewing angle than the “magenta-to-green” optically variable magnetic ink, and chosen such as to match the reflection spectrum of the latter at an oblique viewing angle of 40°, such as disclosed in the co-pending application PCT/IB2008/002620 of the same applicant.

In still another example, a metallic ink (comprising aluminum pigment) was screen-printed in the form of a signature logo on a silicone-release-coated paper carrier. After curing the printed metallic ink, a magenta-to-green optically variable magnetic ink was screen-printed in the form of a circular patch on the signature logo, and magnetically oriented so as to reproduce a shadow of the signature logo. After UV curing, a layer of heat-activate-able adhesive was applied over the optically variable magnetic ink, and the printed patch was heat-transferred to an uncoated paper substrate such as disclosed above.

1. Transfer foil, comprising a release-coated carrier (1), and on said carrier a transfer coating layer (3) in the form of a design, characterized in that the transfer coating layer (3) comprises oriented optically variable magnetic pigment (OVMP) particles.

2. Transfer foil according to claim 1, wherein the pigment particle orientation represents an image, indicia, or a pattern.

3. Transfer foil according to claim 1, wherein the optically variable magnetic pigment (OVMP) is a thin-film interference pigment chosen from the group consisting of the Fabry-Pérot type interference pigments, and the refractive-index-modulated type interference pigments.

4. Transfer foil according to claim 1, wherein said optically variable magnetic pigment (OVMP) is chosen from the group consisting of the pigments comprising a 5-layer sequence of absorber layer, dielectric layer, reflector layer, dielectric layer, absorber layer, wherein the reflector layer and/or the absorber layer is a magnetic layer, and the pigments comprising a 7-layer sequence of absorber layer, dielectric layer, reflector layer, magnetic layer, reflector layer, dielectric layer, absorber layer.

5. Transfer foil according to claim 1, wherein the binder resin of said transfer coating layer (3) is chosen from the group consisting of the thermoplastic resins, the photo-curable resins, the electron-beam-curable resins and the heat-curable resins.

6. Transfer foil according to claim 1, additionally comprising, at least on part of said transfer coating layer, a layer of heat- or radiation-activate-able adhesive.

7. Transfer foil according to claim 1, additionally comprising, at least on part of it, a top coating layer (6), disposed between the release coated carrier (1) and the transfer coating layer (3).

8. Transfer foil according to claim 1, additionally comprising, at least on part of it, a bottom coating layer (6′), disposed on the transfer coating layer (3) or between the transfer coating layer (3) and the adhesive layer (4).

9. Transfer foil according to claim 1, wherein the transfer coating layer (3) is a composite layer, having zones printed with a first ink comprising oriented optically variable magnetic pigment, and zones printed with a second ink comprising other types of pigments and/or dyes.

10. Transfer foil according to claim 1, wherein a top coating layer (6) or a bottom coating layer (6′) is a metallic layer.

11. Transfer foil according to claim 10, wherein said metallic layer represents or carries indicia.

12. Process for making an optically variable transfer foil, comprising the steps of
a) providing a release-coated carrier (1);
b) optionally coating said carrier (1) with a top coating layer (6);
c) applying onto said release-coated carrier (1) or on said top coating layer (6) a transfer coating layer (3) comprising magnetic or magnetizable optically variable pigment particles (5);
d) magnetically orienting said magnetic or magnetizable optically variable pigment particles (5) in said applied transfer coating layer (3) through the application of an unstructured or an appropriately structured magnetic field;
e) hardening said transfer coating layer (3) comprising the oriented optically variable pigment particles, so as to fix them in their respective positions and orientations;
f) optionally coating said hardened transfer coating layer (3) with a bottom coating layer (6′).

13. Process according to claim 12, comprising the additional step of
g) applying a layer of adhesive onto the transfer coating layer (3) or the bottom coating layer (6′).

14. Process for protecting a document or an article, the process comprising the steps of
a) Applying, onto the document or article, a transfer coating layer (3) from a transfer foil according to claim 1, using an application method chosen from the group consisting of hot-stamping and cold-stamping;
b) removing the carrier (1) from the applied transfer coating layer (3).

15. Use of an optically variable transfer foil according to claim 1 for the protection of a document, a banknote, a passport, an identity card, an access card, a driving license, a credit card, a voucher, a transportation ticket, an event ticket, a tax label, an article or a commercial good.

16. Document, banknote, passport, identity card, access card, driving license, credit card, voucher, transportation ticket, event ticket, tax label, article or commercial good, carrying a transfer coating layer (3) from a transfer foil according to claim 1.
